(19) United States
(12) Patent Application Publication
(10) Pub. No.: US 2016/0224524 A1
(43) Pub. Date: Aug. 4, 2016

(54) USER GENERATED SHORT PHRASES FOR AUTO-FILLING, AUTOMATICALLY COLLECTED DURING NORMAL TEXT USE

(71) Applicant: Nuance Communications, Inc., Burlington, MA (US)

(72) Inventors: David J. Kay, Burlington, MA (US); Brian Yee, Burlington, MA (US); Donni McCray, Burlington, MA (US); Erland Unruh, Burlington, MA (US)

(21) Appl. No.: 14/613,268

(22) Filed: Feb. 3, 2015

(51) Int. Cl. G06F 17/24; G06F 17/30; G06F 17/27

(52) U.S. Cl. CPC G06F 17/24; G06F 17/2775; G06F 17/276; G06F 17/3056

(57) ABSTRACT

A system and method that learns phrases from scratch based on capturing text entered on electronic devices by a user along with context for the captured text. The system constructs phrase resources based on analysis of the user's phrase usage in various contexts. By identifying similar or matching contexts for phrases employed by the user, the system dramatically improves the ability to predict phrases intended by the user. The disclosed system provides context-based text input that uses phrases previously entered by the user in similar contexts to provide meaningful phrase suggestions, as well as phrase completion suggestions taking into account previously entered text. In some implementations, the system utilizes linguistic models based on conditional probabilities to identify and/or rank suggested phrases for the relevant context.

### BACKGROUND

Users of electronic devices enter billions of text messages each year, in addition to authoring emails, instant messages, Tweets, status updates, blog entries, notes, forms, and all manner of other documents and communications. As demand for text entry increases, developers are challenged to provide reliable, efficient, and convenient text entry features in devices of varying processing power, size, and input interfaces.

Various approaches attempt to ease text entry by reducing the amount a user must type or write (e.g., on a keyboard, keypad, or screen) to obtain the desired text. One conventional approach to ease text entry is the use of explicitly programmed shortcuts that can be chosen from a list or that are expanded from a few characters to a longer word, phrase, or block of text. For example, a text entry application may offer a prepopulated list of options such as “Can't talk now”, or recognize the shortcut “brb” and replace it with the expanded text “be right back” (or perhaps “I'll be right back!”), or replace a misspelled word like “youll” with “you'll.” Such “canned” shortcuts may be set up by, for example, a device manufacturer, a software provider, or a vendor. Such shortcuts may also be explicitly created or modified by a user.

Another conventional approach to easing text entry is an autocomplete or auto-fill in feature. For example, Web browsers commonly include a feature to fill in data in Web page form fields using data explicitly designated for that purpose. Such form completion features leverage metadata in Web page markup (e.g., HTML <label> tags on fields for name, address, or ZIP code data) to insert memorized values for tagged fields.

As electronic devices become increasingly widespread and sophisticated, word-by-word predictive text entry has become more common. Language systems often provide predictive features that suggest word completions, corrections, and/or possible next words for one or more modes of input (e.g., text, speech, and/or handwriting). Language systems typically rely on language models that may include, for example, lists of individual words (unigrams) and their relative frequencies of use in the language, as well as the frequencies of word pairs (bigrams), triplets (trigrams), and higher-order n-grams in the language. For example, a language model for English that includes bigrams would indicate a high likelihood that the word “degrees” will be followed by “Fahrenheit” and a low likelihood that it will be followed by “lake”. In general, language models thus support next word prediction for easing user text entry.

Unfortunately, conventional approaches to easing text entry have significant disadvantages, especially in the use case of conversations via mobile devices. For instance, programmed “canned” shortcuts (e.g., a predefined message such as “In a meeting” or a rule that expands “OMW” to “On my way!”) offer limited flexibility, may not reflect a user's actual language use, may not match the user's desired content or tone, and require time and energy for a user to explicitly enter or modify. If a user does not explicitly set shortcuts up, they are typically hard to discover and unlikely to be exactly what the user would say. Even if a user decides to spend time modifying such shortcuts, the user may not anticipate his or her own phrase usage in various contexts (which may change over time as well), and the user must then remember particular recognized abbreviations for those abbreviations to be expanded into desired text.

The form autocomplete or auto-fill-in feature approach to easing text entry is another example approach that has significant disadvantages. Form filling is limited in that it typically relies on metadata for identifying the specific type of memorized data that belongs in a particular field. For example, to suggest ZIP code data, a form filling approach would identify a field labeled “ZIP” or “zipcode” in an address form, and would require information from the user to have been explicitly saved by the user for future entry in such a tagged field. Well labeled fields, however, are not common outside of Web page address forms and username/password fields. For example, a text entry field for general conversational use (e.g., an SMS message text box) does not include a convenient label that identifies a specific value for entry in the field. Without metadata indicating what specifically targeted data should be suggested for a field, form filling is of little, if any, use to suggest a user's desired phrase. In general, the form filling approach is not available or workable for user phrase prediction.

Finally, there are significant disadvantages in next word prediction for easing user text entry. For example, a language model-based next word prediction feature provides predictions one word at a time, based, e.g., on the preceding word or words. To the extent it is possible to extend an n-gram-based language model from next word prediction to next phrase prediction, increasing extrapolation will cause increasing loss of confidence. For example, the likelihood of accurately predicting the nth word in an n-gram from the n-1st word is much greater than the likelihood of accurately predicting the n-4th, n-3rd, n-2nd, n-1st, and nth words in an n-gram from the n-5th word to predict an entire phrase intended by the user. Moreover, a next word prediction feature extrapolates such phrase possibilities from a current text buffer, and thus does not provide phrase suggestions relevant to the current context beyond that text buffer—for example, phrase suggestions responsive to conversational content from someone else—and specifically tailored to the user's likely intended response.

In view of the shortcomings of conventional approaches to easing text entry, especially in the context of predicting phrases in a conversational setting, a new approach to phrase prediction would have significant utility.

### BRIEF DESCRIPTION OF THE DRAWINGS

FIG. 1 is a block diagram showing some of the components typically incorporated in computing systems and other devices on which the system is implemented.

FIG. 2 is a system diagram illustrating an example of a computing environment in which the system can be utilized.

FIG. 3 is a flow diagram illustrating a set of operations for identifying user-entered phrases in context.

FIG. 4 is a flow diagram illustrating a set of operations for suggesting a saved phrase to enter in an active input field.

FIG. 5 is a flow diagram illustrating a set of operations for suggesting a saved phrase as a user enters text, and for determining and recording a phrase in the entered text.

FIG. 6 is a diagram showing sample contents of a phrase and context table.

FIG. 7 is a diagram illustrating an example user interface for phrase suggestion.

FIG. 8 is a diagram illustrating an example user interface for phrase selection.

### DETAILED DESCRIPTION

The headings provided herein are for convenience only and do not necessarily affect the scope or meaning of the claimed invention.

### OVERVIEW

Disclosed herein is a system and method that learns phrases from scratch based on capturing text entered on electronic devices by a user along with context for the captured text. The system constructs phrase resources based on analysis of the user's phrase usage in various contexts. By identifying similar or matching contexts for phrases employed by the user, the system dramatically improves the ability to predict phrases intended by the user.

The disclosed system provides context-based text input that uses phrases previously entered by the user in similar contexts to provide meaningful phrase suggestions, as well as phrase completion suggestions taking into account already-entered text (e.g., words and/or letters to the left of the insertion point, for a left-to-right language) that the suggested phrases can complete and/or replace. For purposes of this description, a “phrase” is a series of two or more words. In some implementations, the system utilizes linguistic models based on conditional probabilities to identify and/or rank suggested phrases for the relevant context. By ordering suggested phrases in a way that puts more likely candidate phrases first, the disclosed system improves convenience and increases text entry speeds while reducing frustration and easing the cognitive work required of the user, improving user satisfaction. The system learns phrases on the fly, recognizes appropriate context, and predicts and suggests a phrase or phrases.

In various implementations, the disclosed system includes receiving context information, e.g., the identity of an active application associated with the input field, the name of an addressee with whom the user is conversing, the content of a message that the user is responding to, or information characterizing the environment of the computing device (e.g., the user's location, speed, time of day, day of the week, or networked device connection data). The system uses the received context to identify, rank, and suggest phrases associated with a similar or matching context. In addition, the system updates or modifies the matching phrases as the context changes (e.g., as the user enters text).

By presenting a list of likely phrases based on phrases the user actually uses instead of canned phrases, and by suggesting phrases based on calculating similarities between previous phrases' contexts and the current context, the system can anticipate what a user actually would want to write, speeding the user's text entry in a satisfying way. By ensuring that suggested phrases are appropriate to the current context, the system enables, for example, a user interface that indicates a matching phrase is available on or near the keyboard before the user has entered any text at all. In the wearable computing market, text entry assistance that limits the number of characters required to get desired text is a potentially valuable market differentiator. The disclosed system accurately predicts an intended phrase, requiring less user input to anticipate a desired phrase.

A system that automatically recognizes and suggests phrases actually used by the user in context provides a superior user text entry experience for several reasons. For example, by anticipating phrases based on text that the user previously entered, the system is more likely to suggest wording that the user is comfortable with using. By not requiring explicit action by the user to set up phrases for suggestion, the system reduces the work required of the user and increases the likelihood that phrase suggestions will actually be used by the user. And by suggesting phrases from the user, who may be using a language for which canned responses are not provided, the system can serve populations in a variety of markets.

### DESCRIPTION OF FIGURES

The following description provides certain specific details of the illustrated examples. One skilled in the relevant art will understand, however, that the system can be practiced without many of these details. Likewise, one skilled in the relevant art will also understand that the system can include many other obvious features not described in detail herein. Additionally, some well-known structures or functions may not be shown or described in detail below, to avoid unnecessarily obscuring the relevant descriptions of the various examples.

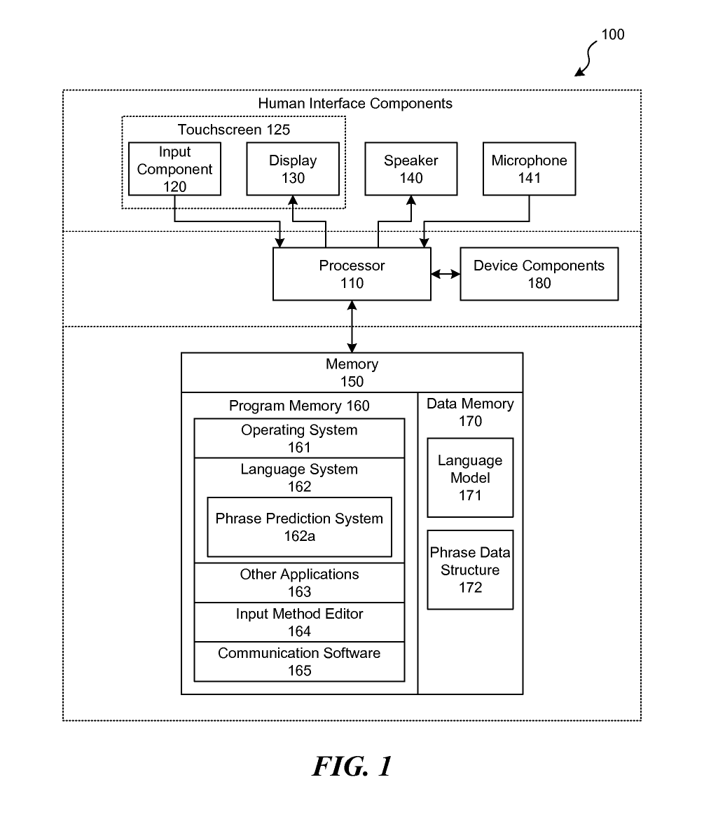

FIG. 1 is a block diagram showing some of the components typically incorporated in at least some of the computer systems (e.g., mobile devices such as smartphones or tablets, wearable devices such as smartwatches, computers such as personal computers or laptops, servers or other multi-user platforms) on which a system that provides phrase suggestions is implemented. The computing system 100 includes one or more input components 120 that provide input to a processor 110, notifying it of actions performed by a user, typically mediated by a hardware controller that interprets the raw signals received from the input device and communicates the information to the processor 110 using a known communication protocol. The processor can be a single CPU or multiple processing units in a device or distributed across multiple devices. Examples of an input component 120 include a keyboard, a pointing device (such as a mouse, joystick, dial, or eye tracking device), and a touchscreen 125 that provides input to the processor 110 notifying it of contact events when the touchscreen is touched by a user. Similarly, the processor 110 communicates with a hardware controller for a display 130 on which text and graphics are displayed. Examples of a display 130 include an LCD or LED display screen (such as a desktop computer screen or television screen), an e-ink display, a projected display (such as a heads-up display device), and a touchscreen 125 display that provides graphical and textual visual feedback to a user. Optionally, a speaker 140 is also coupled to the processor so that any appropriate auditory signals can be passed on to the user as guidance, and a microphone 141 is also coupled to the processor so that any spoken input can be received from the user, e.g., for systems implementing speech recognition as a method of input by the user (making the microphone 141 an additional input component 120). In some implementations, the speaker 140 and the microphone 141 are implemented by a combined audio input-output device. The computing system 100 can also include various device components 180 such as sensors (e.g., GPS or other location determination sensors, motion sensors, and light sensors), cameras and other video capture devices, communication devices (e.g., wired or wireless data ports, near field communication modules, radios, antennas), haptic feedback devices, and so on. Device components 180 can also include various input components 120, e.g., wearable input devices with accelerometers (e.g. wearable glove-type input devices), or a camera or other imaging or sensing input device to identify user movements and manual gestures, and so forth.

The processor 110 has access to a memory 150, which can include a combination of temporary and/or permanent storage, and both read-only memory (ROM) and writable memory (e.g., random access memory or RAM), writable non-volatile memory such as flash memory, hard drives, removable media, magnetically or optically readable discs, nanotechnology memory, biological memory, and so forth. As used herein, memory does not include a transitory propagating signal per se. The memory 150 includes program memory 160 that contains all programs and software, such as an operating system 161, language system 162, and any other application programs 163. The program memory 160 can also contain input method editor software 164 for managing user input according to the disclosed technology, and communication software 165 for transmitting and receiving data by various channels and protocols. The memory 150 also includes data memory 170 that includes any configuration data, settings, user options and preferences that may be needed by the program memory 160 or any element of the computing system 100.

In various implementations, the language system 162 includes components such as a phrase prediction system 162a for collecting phrases in context and suggesting phrases as described herein. In some implementations, the language system 162 and/or phrase prediction system 162a is incorporated into an input method editor 164 that runs whenever an input field (for text, speech, handwriting, etc.) is active. Examples of input method editors include, e.g., a Swype® or XT9® text entry interface in a mobile computing device. The language system 162 can also generate graphical user interface screens (e.g., on display 130) that allow for interaction with a user of the language system 162 and/or the phrase prediction system 162a. In some implementations, the interface screens allow a user of the computing device to set preferences, modify stored phrases, select phrase suggestions, and/or otherwise receive or convey information between the user and the system on the device. In some implementations, the phrase prediction system 162a is independent from the language system 162 or does not require a language system 162.

Data memory 170 also includes, in accordance with various implementations, one or more language models 171. A language model 171 includes, e.g., a data structure (e.g., a list, array, table, or hash map) for words and/or n-grams (sets of n words, such as three-word trigrams) based on general or individual user language use. In accordance with various implementations, data memory 170 also includes a phrase data structure 172. In some implementations, the system maintains phrases in its own phrase data structure 172, separate from, e.g., other language model 171 data structures. In some implementations, the phrase data structure 172 is combined with or part of another data structure such as a language model 171. In various implementations, the phrase data structure 172 stores phrases (and/or potential phrase candidates), contextual information related to phrases, information regarding, e.g., probability, recency, and/or frequency of use of phrases, gestures mapped to phrases, information about user selection or rejection of phrase suggestions, etc.

The phrase prediction system 162a can use one or more input components 120 (e.g., keyboard, touchscreen, microphone, camera, or GPS sensor) to detect context associated with user input and/or a user input field on a computing system 100. The system can use context associated with user input to modify the contents of phrase data structure 172, e.g., for recording a phrase in context. The system can use context associated with a user input field (which can include user input in the field) to identify relevant contents of phrase data structure 172, e.g., for suggesting a phrase in context. In various implementations, the system derives context information from the user's interaction with the computing system 100.

FIG. 1 and the discussion herein provide a brief, general description of a suitable computing environment in which the system can be implemented. Although not required, aspects of the system are described in the general context of computer-executable instructions, such as routines executed by a general-purpose computer, e.g., a mobile device, a server computer, or a personal computer. Those skilled in the relevant art will appreciate that the system can be practiced using other communications, data processing, or computer system configurations, e.g., hand-held devices (including tablet computers, personal digital assistants (PDAs), and mobile phones), wearable computers, vehicle-based computers, multi-processor systems, microprocessor-based consumer electronics, set-top boxes, network appliances, mini-computers, mainframe computers, etc. The terms “computer,” “host,” and “device” are generally used interchangeably herein, and refer to any such data processing devices and systems.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through a communications network, such as a local area network (LAN), wide area network (WAN), or the Internet. In a distributed computing environment, modules can be located in both local and remote memory storage devices.

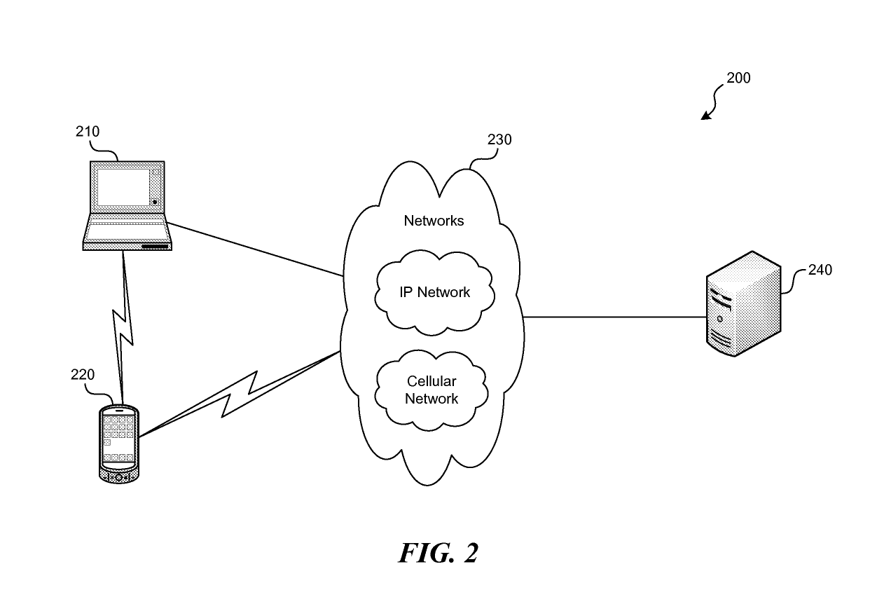

FIG. 2 is a system diagram illustrating an example of a computing environment 200 in which the system can be utilized. As illustrated in FIG. 2, a phrase prediction system 162a can operate on various computing devices, such as a computer 210, mobile device 220 (e.g., a mobile phone, tablet computer, mobile media device, mobile gaming device, wearable computer, etc.), and other devices capable of receiving user inputs (e.g., such as set-top box or vehicle-based computer). Each of these devices can include various input mechanisms (e.g., microphones, keypads, cameras, and/or touch screens) to receive user interactions (e.g., voice, text, gesture, and/or handwriting inputs). These computing devices can communicate through one or more wired or wireless, public or private, networks 230 (including, e.g., different networks, channels, and protocols) with each other and with a system 240 that, e.g., coordinates phrase data structure information across user devices and/or performs computations regarding phrase suggestions. System 240 can be maintained in a cloud-based environment or other distributed server-client system. As described herein, user input (e.g., entry of a phrase in a context or selection of a suggested phrase) can be communicated between devices 210 and 220 and/or to the system 240. In addition, information about the user or the user's device(s) 210 and 220 (e.g., the current and/or past location of the device(s), phrases entered and/or suggested and selected on each device, device characteristics, and user preferences and interests) can be communicated to the system 240. In some implementations, some or all of the system 240 is implemented in user computing devices such as devices 210 and 220. Each phrase prediction system 162a on these devices can utilize a local phrase data structure 172. Each device can have a different end user.

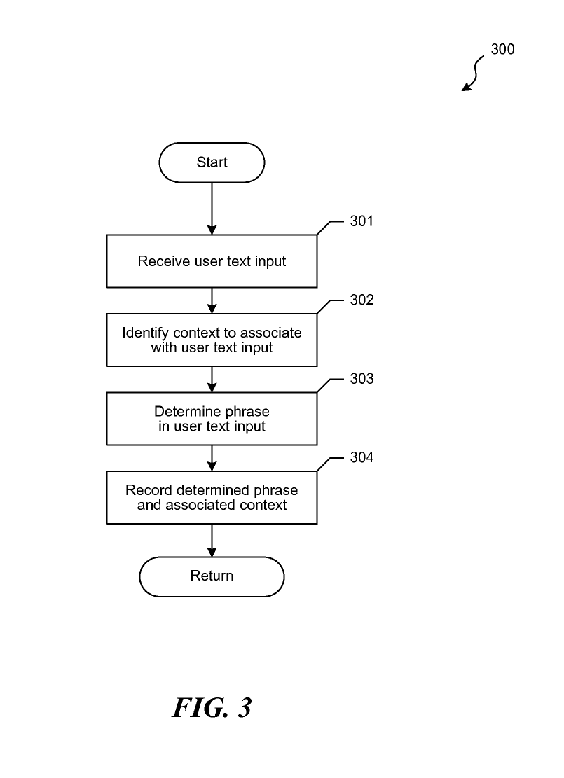

FIG. 3 is a flow diagram illustrating a set of operations for identifying user-entered phrases in context. The operations illustrated in FIG. 3 can be performed by one or more components (e.g., the processor 110, the system 240, and/or the phrase prediction system 162a). At step 301, the system receives user text input (e.g., by voice, keyboard, keypad, gesture, and/or handwriting inputs). The text input is one or more words, numbers, spaces, punctuation, or other characters. Words can include or be characters, numbers, punctuation, symbols, etc. A series of two or more words is hereinafter referred to as a “phrase”.

At step 302, the system identifies information about the context in which the phrase was entered. Examples of context information that the system can identify include the location of the device on which the phrase was received or when the user sent a particular message containing the phrase (e.g., information derived via GPS or cell tower data, user-set location, time zone, language, and/or currency format), the time of day, the day of the week, networked device connection data, the application or applications used by the user in conjunction with the phrase prediction system 162a (e.g., application context such as whether text was entered in a word processing application, an instant messaging application, SMS, Twitter®, Facebook®, email, notes, etc.), what field in the application is active, user interests, the identity of other parties with whom the user is exchanging information (e.g., “TO:” recipient addressees), previous conversation content (e.g., what the addressee and/or the writer and/or other conversation participants previously wrote), and/or information or text recently exchanged to or from the user (e.g., the most recent messages sent to or received from others, and/or inferred user intent), etc. In a conversation between two people, for example, context can include who a person is addressing or responding to, what, if anything, is being replied to, and what time he or she is responding.

In various implementations, the system automatically identifies context information. In some implementations, the system can receive context information designated by a user, a device manufacturer, a service vendor, the system provider, etc. For example, the system can enable a user to manually define context information (e.g., a user identity) and/or set context preferences. In some implementations, the phrase prediction system is provided with an open and/or configurable software development kit (SDK) so that the system can be configured or augmented to gather selected, different, or additional kinds of context information. In some implementations, the system can be configured to automatically identify different types of context information in a non-SMS or non-conversational environment. For example, in a child's game, the context for a phrase could include the screen color, a visual prompt, etc.

At step 303, the phrase prediction system determines a phrase from the user's text input. Depending on the length and content of the text input, the system can identify no phrases, one phrase, or more than one phrase. In various implementations, the system identifies phrases selectively, determining what phrases to save and when to save them. In some implementations, the system defines a “phrase” as a sentence or thought expressed using fewer than some threshold number of words (e.g., seven words). In some implementations, the system defines a phrase as an entire short message, e.g., a sent SMS message. In some implementations, the system includes an interface to allow a user to adjust the length of phrases collected (e.g., in characters or words), or to specify the maximum number of terminal punctuation points (i.e., the number of sentences ended by periods, question marks, exclamation points, etc.) to be collected in a phrase.

In some implementations, the system analyzes longer sentences or paragraphs to search for features typical of phrases that the user is likely to reuse. For example, the system can utilize statistical text analysis to train and tune a model of the user's text input to determine the most salient features (e.g., key words), grammatical structures (e.g., clauses or punctuation), contextual information, and phrase length, among various factors, and then apply that model to determine a phrase to record for the system to suggest in the future. In some implementations, the determination is language-dependent. For example, the system can classify words in a particular language by their part of speech (e.g., verbs, nouns, pronouns, adverbs, adjectives, prepositions, conjunctions, and interjections) or identify words that are especially common in a language (e.g., an article like “the” in English) as a part of determining whether to save a series of words as a phrase for later suggestion. In some implementations, phrases are language independent.

The system can use different trigger points to determine when the system processes entered text to identify phrases. In some implementations, the system gathers information about a message when the user presses “send” or otherwise transmits or commits the message. In some implementations, the system gathers information as the message is entered by the user. For example, the system can determine whether entered text should be recorded as a phrase after the user enters a terminal punctuation mark.

In step 304, the system records the phrase and associates the saved phrase with the identified context in which the phrase was entered. For example, the system can record the phrase locally, such as in the phrase data structure 172 of FIG. 1, and/or remotely, such as on the server 240 of FIG. 2. In some implementations, the system specifically records the exact text content input by the user in association with any context information (e.g., what the input was in response to and when it was input). In some implementations, the system includes approximate matching that associates or merges similar phrases. For example, the system can determine that the phrases “I'll be late” and “I'm running late” are similar (e.g., based on the shared word “late” used in a similar context), and can record the phrases in association with each other, such as in a subtable or other data structure. The system can record their individual frequencies to indicate which form the user prefers, and can combine their frequencies to indicate how commonly the user employs the associated phrases as a group. For another example, although the sentences “What movie do you want to see tonight?” and “Well, which film should we go for?” have no words in common, the system can determine that they are similar based on features such as the synonyms “movie” and “film”, the structure of each sentence as a question ending in a question mark, the context in which each sentence is used (e.g., in response to “Let's go see a movie!”, etc. In other words, the system can search previously stored phrases to identify similar phrases that were entered by the user, and can associate the phrase with the previously stored phrases.

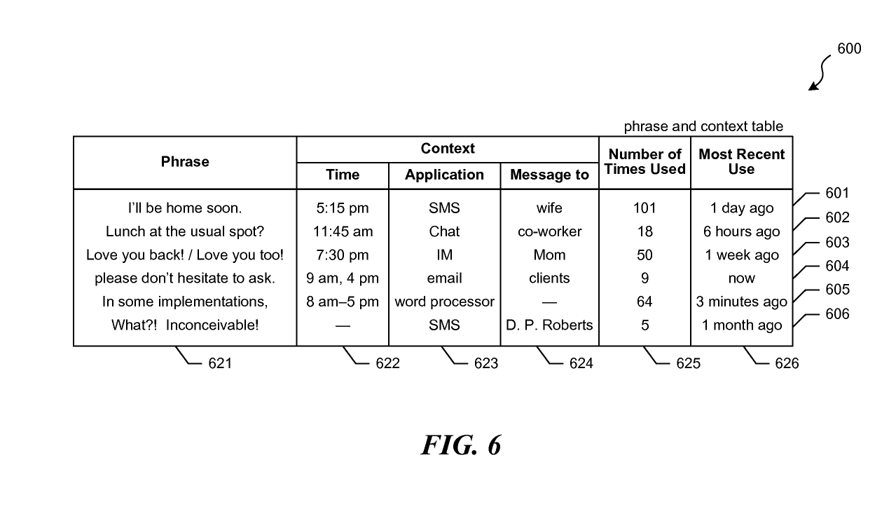

The system saves the phrase and context in, e.g., a phrase and context data structure such as the table described in connection with FIG. 6. After step 304, the system has determined and saved a phrase in association with its context, and the depicted process concludes. As will be described in additional detail herein, the saved phrases and context information can be used to predict the use of the same phrase in similar contexts in the future.

Those skilled in the art will appreciate that the steps shown in FIG. 3 and in each of the flow diagrams discussed below may be altered in a variety of ways. For example, the order of the steps may be rearranged; some steps may be performed in parallel; shown steps may be omitted, or other steps may be included; etc.

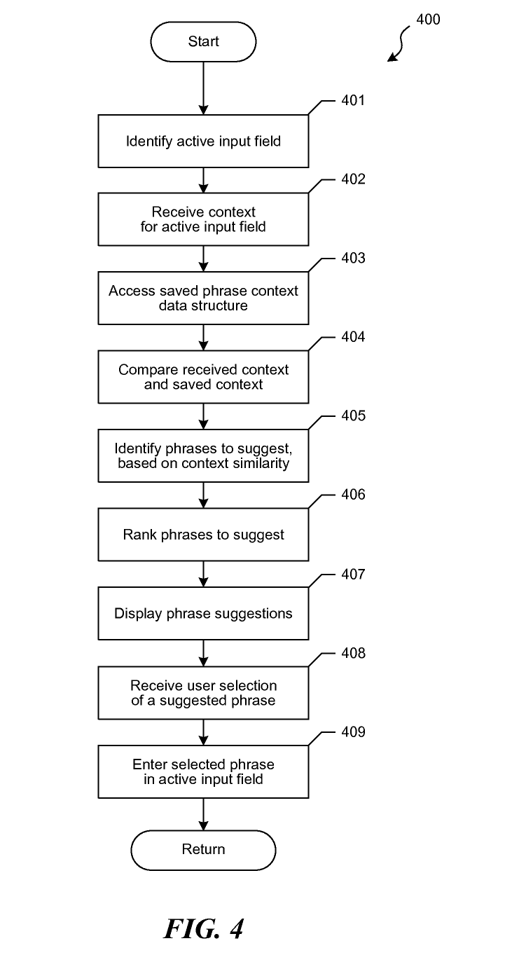

FIG. 4 is a flow diagram illustrating a set of operations for suggesting a saved phrase to enter in an active input field, prior to the user having entered any text. In step 401, the system monitors interfaces being presented to the user and identifies an opportunity to suggest a phrase in an active input field on a user device, e.g., in a text entry box, an email message, an SMS message, or other area or application in which the user can enter text. In step 402, the system identifies context information for the active input field. Examples of context information are described in greater detail above in connection with FIG. 3. Context information includes, for example, the identity of the active input field itself, the time the information was received, the application for which the entry was received, etc. In some implementations, the system identifies context based on more than one device associated with a user, such as a wearable computing device and a handheld computing device. For example, the system can share context information identified with respect to one device that may be relevant to the other, such as information from a tablet computer about a message received on the tablet and displayed to the user on a smartwatch operatively connected to the tablet. In step 403, the system accesses a saved phrase context data structure. In some implementations, the data structure is a phrase and context data structure such as the table described in connection with FIG. 6.

In step 404, the system compares the context information for the active input field with saved context information from the saved phrase context data structure. In some implementations, comparing includes scoring similarities numerically based on exact or approximate matches. For example, the similarity between the current context and a saved context can be scored on a scale of 0-100 or 0-1, in which a low score indicates similar contexts or vice versa. The system can assign scores based on similar features of the current and saved contexts, such as a similar time of day (e.g., 5:01 pm and 5:12 pm) and/or date (e.g., July 4 for both), and/or based on dissimilar features (e.g., different people or different locations). In some implementations, the system weights one or more factors (for example, the system can assign the identity of another party to a conversation or the content of a message being replied to greater importance than which day of the week a conversation occurs). In some implementations, the system analyzes phrase suggestions and user responses for a particular user or across a wider population of users to learn to identify useful context or phrase features and/or weightings, to predict responses with the highest probability of matching the active context and being selected by the user. In some implementations, for example, the system uses artificial intelligence approaches such as decision tree modeling or simulations such as Monte Carlo simulations to train and tune a model of the user's phrase input and or a model of multiple users' phrase input to determine the most salient contextual information for various phrases.

Because the system can compare the active input field context to the context of past input, the system can provide phrase suggestions with a greater likelihood of matching the user's desired input than, e.g., an n-gram-based next word prediction engine or a context-unaware natural language processing system. For example, the system can compare context information including messages previously sent by the user and the content of the user's previous responses to another person's messages. The system thus automatically learns a user's typical input in a particular context.

In step 405, the system identifies, based at least in part on similarity to previous contexts, a previously user-entered phrase or phrases to suggest to the user in the current context of the active input field. For example, after receiving a text message from a family member asking “Coming home soon?”, the system can suggest, based on previous responses, “No, I'm stuck” or “Yes, I'm leaving now.” In some implementations, the system can identify a phrase to suggest before the user has begun to enter text. Depending on the degree of context similarity, the system can identify no phrases, one phrase, or more than one phrase to suggest.

The system can identify phrases to suggest based on context such as a particular time of day. For example, the system can identify a time of day at which a user sends a message to a family member each workday, and suggest a previously-entered phrase by that user associated with that context (e.g., “Leaving now”). As another example, the system can use time of day as a weighting factor to recommend one phrase over another. For example, the system may be more likely to recommend an “I'll be late” message if the time is after 5:00 pm.

The system can also identify phrases to suggest based on context such as a particular location or motion of the user's device. In some implementations, the system can use signals from sensors such as an accelerometer and/or GPS information to determine whether the user is stationary, running, driving, etc. and suggest responses associated with the relevant context.

In some implementations, the system uses a natural language understanding (“NLU”) processing module to identify a phrase to suggest, or to determine or modify a probability for such a candidate phrase. For example, where the active input field is a response to a statement, the context for a phrase suggestion can include the language structure and punctuation of the statement being replied to. The system can interpret a sentence that begins with “When” and ends in a question mark “?” as a temporal question. In response, the system can identify as a more likely response a phrase encompassing a time-related intention, e.g., “I'll be late.”

In some implementations, the system infers or determines that one or more phrases reflecting a common intention could be suggested. For example, as described above with reference to step 304 of FIG. 3, the system can store multiple phrases in association with each other. Such phrases can be related by contextual information and/or similar vocabulary, for example. In some implementations, the system identifies a matching or compatible context or phrase to suggest from among the phrases that reflect the user's intention, whether or not the system explicitly identifies such an intention. For example, someone sending a message to the user may want to go to a movie, and send the user a conversational text message such as “catch you at the movies?” In determining the context for the user's reply, an NLU system can interpret that phrase as related to a phrase such as “Let's go to see a movie.” Based on that context, the system can suggest a phrase that responds to the sender's intention instead of just the explicit text. For example, a user's spouse who is a movie buff may often ask if the user wants to go see a film. The system can learn and automatically generate one or more responses that are typical for the user in the context of replying, e.g., “What do you want to see?” or “Which cinema?”. In some implementations, the system offers a set of suggested phrases.

In step 406, in various implementations, the system ranks multiple phrases for suggestion. Example ranking criteria include, e.g., recency of prior use of a phrase, frequency of use of the phrase (including, for example, how often the user chooses the phrase in a particular context), whether or not the current context matches a previously captured phrase's context, and quality of match between each suggested phrase's context and the current context.

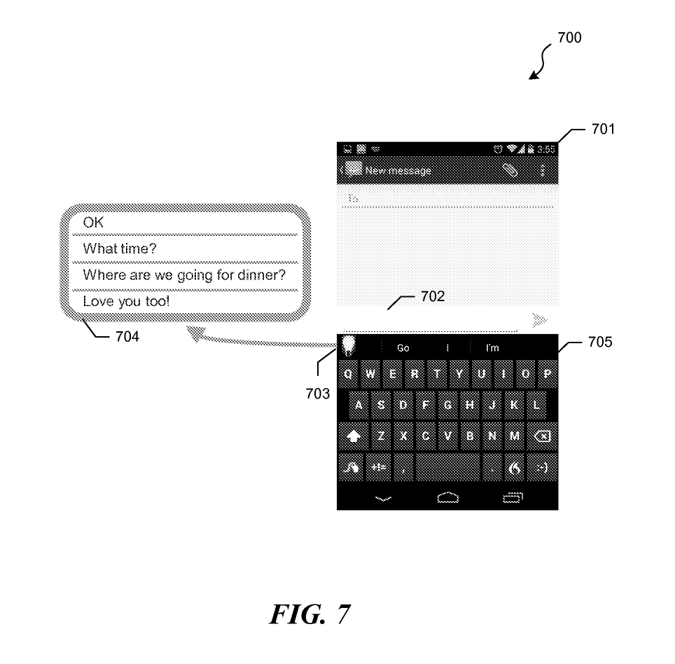

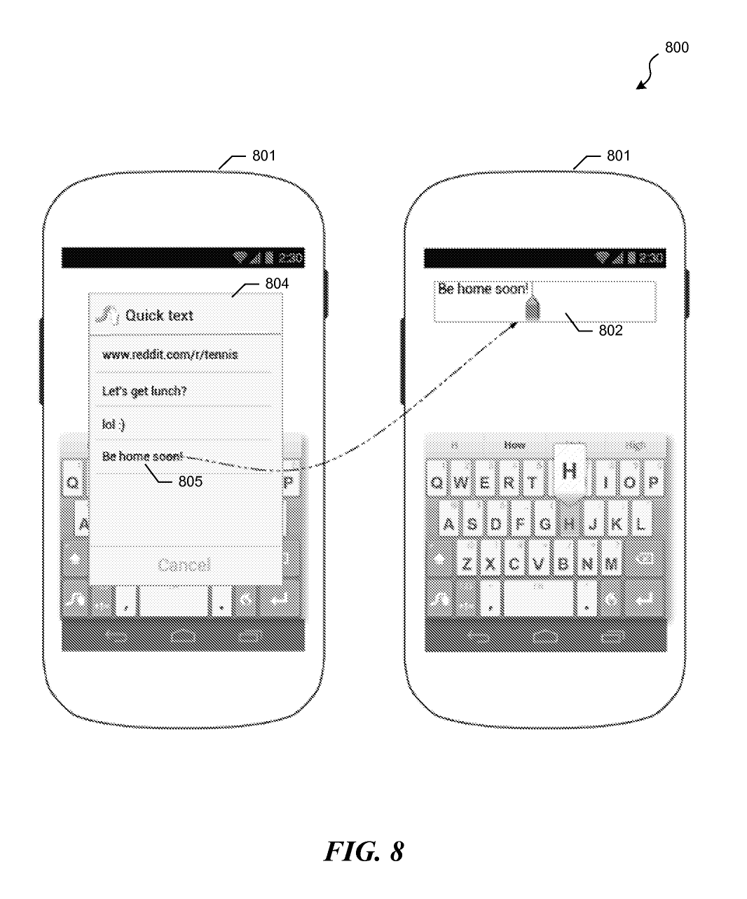

In step 407, the system displays phrase suggestions for user selection. Example user interfaces that let a user choose among various suggested phrase responses are described in greater detail herein in connection with FIG. 7 and FIG. 8. In some implementations, displaying phrase suggestions includes showing a user interface icon or other graphical treatment (e.g., a light bulb icon, as illustrated in FIG. 7) that indicates that the user can choose to have a suggested phrase displayed to the user, while minimizing intrusiveness and use of potentially limited screen space. In some implementations, the system displays phrase suggestions for selection without requiring the user to perform an additional step to reveal the suggestions.

In some implementations, the size and type of the display interface can be used to determine an appropriate phrase to suggest. For example, in a mobile phone SMS text entry field, the system can predict and suggest SMS-style phrases, based on the types of phrases that the user has previously entered in such a field. In a wearable device with a limited interface, on the other hand, the system can suggest shorter phrases. In other contexts (e.g., an email message or word processing document), the system can suggest longer phrases. In some implementations, the system suggests an entire next message.

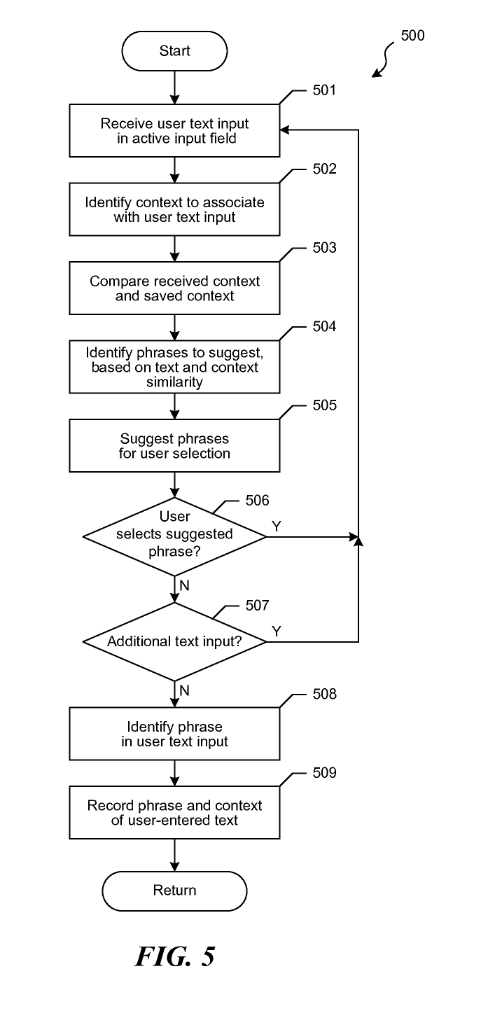

In step 408, the system receives a user selection of a suggested phrase, e.g., via a touchscreen interface or another user input device, and in step 409, the system enters the suggested phrase in the active input field. In various implementations, the system continues to suggest phrases while the input field is active, with the additional context of already-entered text, as described further in connection with FIG. 5. After step 409, the depicted process concludes.

FIG. 5 is a flow diagram illustrating a set of operations for suggesting a saved phrase as a user enters text, and for determining and recording a phrase in the entered text. Notably, the example in FIG. 5 differs from the example in FIG. 4 in that the system utilizes text already entered by the user in addition to context information in order to recommend saved phrases, and in that the system further determines and records phrases from the entered text. (As described above with reference to FIG. 4, the system can suggest phrases in context before the user enters any text.) In step 501, the system receives user text input in an active input field (e.g., by voice, keyboard, keypad, gesture, and/or handwriting inputs). The active input field can be associated with a message, document, application, or the like. In step 502, the system identifies current context information to associate with the user text input. Context information—in this case, the context in which the user has entered or is entering text—is described further above in connection with FIG. 3 and FIG. 4. Unlike the example in FIG. 4 that did not depend on concurrently-entered user text, however, in step 502 the context also includes user-entered text in the active input field. In step 503, the system accesses a saved phrase context data structure, such as the table described below in connection with FIG. 6, and compares the received or identified context information with saved context information from the saved phrase context data structure. Such context comparison is described in further detail above in connection with FIG. 4.

In step 504, the system identifies a phrase or phrases previously entered by the user to suggest to the user in the current context of the active input field. The system can identify phrases to suggest based on context as described above in connection with FIG. 4. Because of the text already entered by the user, however, the system bases the suggestion not only on the similarity between the current context and previous contexts, but also on the similarity or compatibility between the already-entered text and the candidate phrases for suggestion. In various implementations, once a user begins to type, speak, or otherwise enter text, the system filters the suggested phrases to a smaller set of candidate phrases compatible with the entered text. That is, although the context may suggest one set of responses, the system can utilize the previously-entered text to filter out responses that no longer fit as well. The system can suggest a phrase based on one or more conditional probabilities for a candidate phrase given the current context including current contents of the active input field. For example, if the user is responding to a question such as, “When are you coming to visit?”, and the top phrase suggestion candidates in that context are “I don't know” and “Friday,” then the letter “F” in the active input field makes “Friday” much more likely and “I don't know” much less likely. In this example, therefore, the system identifies “Friday” as a response and filters out “I don't know” so that the system does not identify “I don't know” as a phrase to suggest, even if “I don't know” would otherwise be the top suggestion. As another example, the system can identify compatible phrases based on similarity of whole and/or partial words throughout a phrase (not just the first word of a phrase), so that if the user types “soo”, the system can suggest, e.g., “I'll be home soon” as a phrase compatible with the entered text.

In various implementations, the system uses filtering mechanisms to better predict suggested phrases from saved user phrases. For example, the system can identify the most frequently used phrases to recommend, merge similar phrases (such as described above with reference to step 304 of FIG. 3), and/or favor short phrases over longer ones when making a recommendation. In some implementations, the system can filter phrases by comparing, e.g., how many words match or are similar, word positions in a phrase, word types (e.g., noun, imperative verb, chatspeak abbreviation, et al.), previous use in a particular context, etc., and choosing only the best matches.

In step 505, the system suggests the identified phrases to the user. The system can immediately present an identified phrase or phrases to the user when the suggested phrases exceed a threshold likelihood for the particular context. Alternatively, the system can provide a graphical indication to the user that that suggested phrases are available. The graphical indication can take the form of an icon or other treatment that indicates the availability of a phrase suggestion. When the user selects the icon or other graphical treatment, the system presents the identified phrase or phrases to the user. Similarly, the system can remove or change the icon or other graphical indication when no phrases match the received text.

In step 506, if the user selects one of the suggested phrases, the process continues with step 501, receiving the selected phrase and inserting that phrase into the active input field at the current text insertion point. The system can insert the selected phrase by replacing or completing user-entered text related to the suggested phrase. For example, if the user types “home” and selects the suggested phrase, “I'll be home soon,” the system can replace “home” with the selected phrase or insert “I'll be” to the left of “home” and “soon” to its right (and, e.g., move the insertion point to the end of the inserted phrase). Otherwise, if the user does not select one of the suggested phrases, the process continues with step 507. In step 507, if additional text is input by the user, the process continues with step 501, receiving the user text input in the active input field. After the user selects a suggested phrase in step 506 or enters additional text in step 507, the system repeats the process of steps 501-505 and determines a phrase to suggest based on the additionally-received text, whether the additional text input is, e.g., characters input by the user or a user-accepted phrase suggestion. As the user enters text, the system continues to evaluate candidate phrases in context and updates the suggested phrases so that matching phrases remain or become available.

If no more text is input—e.g., if the user enters no text for a time greater than a threshold duration, presses <send> to transmit an entered text or email message, or saves and closes a document—the process continues from step 507 to step 508. In step 508, the system assesses the user's entered text input to identify phrases to store for future recommendation purposes. The system can identify phrases that include, exclude, and/or overlap with a phrase suggestion accepted by the user. The system can determine phrases such as described above in connection with FIG. 3. In step 509, the system records the determined phrase and associates the saved phrase with the identified context in which the phrase was entered. The system can record a phrase in context such as described above in connection with FIG. 3. After step 509, the depicted process concludes.

FIG. 6 is a diagram depicting sample contents of a phrase and context table. The phrase and context table 600 is made up of rows 601-606, each representing a phrase used by a user that the system has saved for potential suggestion, and contextual information and metadata related to the phrase. Each row is divided into several columns. The first set of columns reflect the particular phrase and circumstances surrounding the use of the phrase. That is, each row includes a phrase column 621 containing a phrase from the user and context columns 622-624 containing different pieces of context associated with the use of the phrase. Context columns can include, for example, a time column 622 containing a time of day associated with the user's use of the phrase, an application column 623 containing a type or name of an application in which the user used the phrase, and a “message to” column 624 containing a name or identifier for an entity to whom the user addressed the phrase. The last set of columns reflect the timing and use of the phrase. That is, the row includes a “number of times used” column 625 containing the user's frequency of use of the phrase (e.g., over some time period) and a “most recent use” column 626 containing information about the recency of the user's last use of the phrase.

For example, row 601 indicates that the user uses the phrase “I'll be home soon” around 5:15 pm in SMS messages to his wife, a total of 101 uses as recently as yesterday. Row 602 indicates that the user uses the phrase “Lunch at the usual spot?” before noon in a chat application with a co-worker, a total of 18 times, most recently six hours ago. The row 602 phrase's context can include use of the phrase to initiate a conversation with another person. By comparison, row 603 indicates that the user responds “Love you back!” or “Love you too!” to his mother in evening IM conversations, a total of 50 times, the last a week before. Row 603 illustrates the system associating two similar phrases used in similar context, and combining the frequency and recency of the phrases to reflect the user's actual usage. Additional context might show that the user typically sends row 603's “Love you too!” message in response to a “Love you!” message from his Mom. Row 604 shows that the user utilizes the phrase “please don't hesitate to ask” in email with clients at two times during the day, nine times total, and no time ago. The multiple time values in row 604 and the 8 am-5 pm time range in row 605 indicate that the system has identified uses of the phrase at various times and can correlate the use with more than one value. Similarly, the “clients” designation indicates multiple contacts to whom the user has sent email with the phrase, which can be aliased outside the phrase and context table 600. Row 605 indicates that the user uses the phrase “In some implementations,” in a word processing application during business hours, with no addressee, a total of 46 times and within the last few minutes. Row 605 shows an example of the system determining and saving a phrase used in a non-conversational context. Row 606 indicates that the user uses the phrase “What?! Inconceivable!” at various times in SMS messages to a D. P. Roberts, five times in total, most recently one month ago. The table 600 thus shows the system storing short phrases utilized by a user in various contexts.

Though the contents of phrase and context table 600 are included to present a comprehensible example, those skilled in the art will appreciate that the system can use a phrase and context table having columns corresponding to different and/or a larger number of categories, as well as a larger number of rows. For example, a separate table can be provided for each device owned by a user. Additional types of context information that can be used include, for example, location information, date and day information, specific active application field data, the content of messages being replied to, an intent of the phrase, etc. In some implementations, phrases and context are stored separately or cross-referenced, e.g., by hash values. Though FIG. 6 shows a table whose contents and organization are designed to make them more comprehensible by a human reader, those skilled in the art will appreciate that actual data structures used by the system to store this information may differ from the table shown. For example, they may be organized in a different manner (e.g., in multiple different data structures); may contain more or less information than shown; may be compressed and/or encrypted; etc.

FIG. 7 is a diagram illustrating an example user interface 700 for phrase suggestion. FIG. 7 shows a mobile phone message screen 701 with a virtual keyboard 705 and text entry field 702 for entering a message. In the illustrated example, the system includes a user interface element of a light bulb icon 703 that changes state to indicate when suggested phrases are available for recommendation. Use of an icon minimizes the amount of screen real estate required to show recommendations are available. For example, when the user starts to enter a new SMS text message, the system can display the icon to indicate that a phrase commonly used by the user in the relevant context is available to be recommended. When the user selects or otherwise activates the light bulb icon 703, a selection dialog box 704 is displayed by the system. The selection dialog box 704 lists recommended phrases and allows the user to select a desired phrase to use. In some implementations, the system displays one or more phrases (e.g., three phrase suggestions) or beginnings of phrases on the screen of a device near where the user is entering text, for example, above a virtual or physical keyboard or at a text entry insertion point, without requiring a user interface element to be selected by the user before the user can select a suggested phrase to enter. In some implementations, the system offers phrases directly when a text field is initially opened, and if the user instead begins to enter text without accepting a suggestion, hides the suggested phrases. In some implementations, user selection of a user interface element inserts a phrase directly into a text field. For example, tapping on the light bulb icon 703 when it is lit can cause the most likely recommend phrase to be automatically inserted into the text field.

FIG. 8 is a diagram illustrating an example user interface 800 for phrase selection. FIG. 8 shows a mobile device 801 with a text entry field 802. In the illustrated example, a gesture or shortcut allows the user to select a phrase suggestion from a list of relevant phrase suggestions 804. In the illustrated example, the user selects a suggested phrase 805, which is inserted into the active input field 802.

### CONCLUSION

The above Detailed Description of examples of the disclosure is not intended to be exhaustive or to limit the disclosure to the precise form disclosed above. While specific examples for the disclosure are described above for illustrative purposes, various equivalent modifications are possible within the scope of the disclosure, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various examples described above can be combined to provide further implementations of the disclosure. Single components disclosed herein may be implemented as multiple components, functions indicated to be performed by one component may be performed by another component, software components may be implemented on hardware components, and different components may be combined. Some alternative implementations of the disclosure may include not only additional elements to those implementations noted above, but also may include fewer elements.

These and other changes can be made to the disclosure in light of the above Detailed Description. While the above description describes certain examples of the disclosure, and describes the best mode contemplated, no matter how detailed the above appears in text, the disclosure can be practiced in many ways. Details of the system may vary considerably in its specific implementation, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

We claim:

1. A method of suggesting a phrase in an input field of a computing device having a processor, the method comprising:
populating a phrase data structure associated with a user by:
receiving text input by the user of the computing device, wherein the text input includes a phrase;
identifying a context for the text input;
identifying the phrase in the text input; and
automatically storing in the phrase data structure the identified phrase in association with the identified context; and
recommending phrases to the user by:
detecting a context for the input field;
comparing, by the processor, the detected context and the contexts of stored phrases in the phrase data structure in order to automatically identify one or more stored phrases as suggested phrases for the user;
ranking the suggested phrases based on the detected context;
displaying the suggested phrases to the user;
receiving a selection of a phrase by the user from the displayed suggested phrases; and
entering the selected phrase in the input field.

2. The method of claim 1 wherein identifying context for the text input includes identifying at least one of a time of day, an application associated with the input field, an addressee of a message associated with the text input, or information characterizing the environment of the computing device.

3. The method of claim 1 wherein the text input is in response to text received from an addressee, and wherein the identified context includes the text received from the addressee.

4. The method of claim 1 wherein identifying the phrase in the text input comprises characterizing a sentence in the text input as a phrase or characterizing the entire text input as a phrase.

5. The method of claim 1 wherein identifying the phrase in the text input includes analyzing the text input to identify one or more of key words, grammatical structures, context, and phrase length.

6. The method of claim 1 wherein comparing the detected context and the contexts of stored phrases to automatically identify one or more stored phrases as suggested phrases includes determining a numerical score characterizing the similarity between the identified context and the detected context.

7. The method of claim 6 wherein determining a numerical score characterizing the similarity between the identified context and the detected context includes weighting one or more context factors.

8. The method of claim 1 wherein comparing the detected context and the contexts of stored phrases to automatically identify one or more stored phrases as suggested phrases includes determining a conditional probability that a user intends a suggested phrase, given a similarity between the identified context and the detected context.

9. The method of claim 1 wherein ranking the suggested phrases based on the detected context includes determining a conditional probability that a user intends a suggested phrase, given a similarity between the identified context and the detected context.

10. The method of claim 1, further comprising:
receiving, in the input field, one or more characters or words;
comparing, by the processor, the received one or more characters or words and the text of stored phrases; and
modifying the ranking of suggested phrases, based on the comparing.

11. The method of claim 10 wherein comparing the one or more characters or words and the text of stored phrases includes:
determining, based on the received one or more characters or words, an expected word or type of word; and
comparing the expected word or type of word and the text of stored phrases.

12. The method of claim 10 wherein comparing the one or more characters or words and the text of stored phrases includes approximate matching.

13. The method of claim 1 wherein displaying the suggested phrases includes displaying an indicator that a phrase is available for user selection.

14. A computer-readable memory storing computer-executable instructions for causing a computing system having a processor to perform a method for suggesting a phrase in an input field, the method comprising:
populating a phrase data structure associated with a user by:
receiving text input by the user of the computing device, wherein the text input includes a phrase;
identifying a context for the text input;
identifying the phrase in the text input; and
automatically storing in the phrase data structure the identified phrase in association with the identified context; and
recommending phrases to the user by:
detecting a context for the input field;
comparing, by the processor, the detected context and the contexts of stored phrases in the phrase data structure in order to automatically identify one or more stored phrases as suggested phrases for the user;
ranking the suggested phrases based on the detected context;
displaying the suggested phrases to the user;
receiving a selection of a phrase by the user from the displayed suggested phrases; and
entering the selected phrase in the input field.

15. The computer-readable memory of claim 14 wherein the suggested phrase includes three or more words.

16. The computer-readable memory of claim 14 wherein the comparing to automatically identify one or more stored phrases as suggested phrases includes predicting a phrase that the user has not explicitly saved as a shortcut.

17. The computer-readable memory of claim 14 wherein automatically storing the identified phrase in association with the identified context or comparing to automatically identify one or more stored phrases as suggested phrases includes filtering to associate similar phrases.

18. A computing system for suggesting a phrase in an input field, the system comprising:
at least one memory storing computer-executable instructions of:
an input interface configured to receive text entry input by a user and selection input by the user;
a context detection component configured to detect context information related to the text entry input;
a phrase identification component configured to automatically identify a phrase in the text entry input;
a phrase data storage component configured to store the identified phrase in a phrase data structure in association with the detected context information related to the phrase;
a phrase suggestion component configured to:
identify similarities between the context information detected by the context detection component and the context information stored by the phrase data storage component; and
rank one or more stored phrases for suggestion based on the identified similarities;
a display component configured to display ranked phrase suggestions; and
a phrase insertion component configured to, in response to the selection input selecting a phrase suggestion, enter the selected phrase in the input field; and
at least one processor for executing the computer-executable instructions stored in the at least one memory.

19. The system of claim 18 wherein the phrase data storage component includes one or more of a local or remote database.

20. The system of claim 18 wherein the phrase suggestion component is further configured to:
compare one or more text entry input characters or words and the text of stored phrases;
filter phrases for suggestion based on the comparison; and
modify, based on the comparison, the ranking of stored phrases for suggestion.
